(19) United States
(12) Patent Application Publication
(10) Pub. No.: US 2022/0314330 A1
(43) Pub. Date: Oct. 6, 2022

(54) MOLD PREPARATION AND PASTE FILLING

(71) Applicant: Tritone Technologies Ltd., Rosh HaAyin (IL)

(72) Inventors: Ofer BEN-ZUR, Hod-HaSharon (IL); Eli KEDAR, Beit-Dagan (IL); Alon FELDMAN, Kibbutz Kfar-Menachem (IL)

(73) Assignee: Tritone Technologies Ltd., Rosh HaAyin (IL)

(21) Appl. No.: 17/626,536

(22) PCT Filed: Jul. 10, 2020
(86) PCT No.: PCT/IL2020/050777

§ 371 Date: Jan. 12, 2022

Related U.S. Application Data
(60) Provisional application No. 62/873,909, filed on Jul. 14, 2019.

(51) Int. Cl. B22F 12/67; B33Y 10/00; B33Y 30/00; B28B 1/00; B22F 10/10; B22F 12/63; B28B 7/34; B22F 12/53

(52) U.S. Cl. CPC B22F 12/67; B33Y 10/00; B33Y 30/00; B28B 1/001; B22F 10/10; B22F 12/63; B28B 7/346; B22F 12/53

(57) ABSTRACT

A layering device for preparation of layers being formed in additive manufacture, each layer formed by printing a mold wall to define a mold space and filling the mold space with a paste to form the layer. The layering device comprises a roller to press the mold wall from above to form a mold layer surface in a plane, a paste applicator and a blade to spread the paste to fill the mold space. The blade is aligned into the plane to smooth the paste flush with the mold layer surface.

### RELATED APPLICATION/S

This application claims the benefit of priority of U.S. Provisional Patent Application No. 62/873,909 filed on Jul. 14, 2019, the contents of which are incorporated herein by reference in their entirety.

### FIELD AND BACKGROUND OF THE INVENTION

The present invention, in some embodiments thereof, relates to a process of mold preparation and paste filling of the mold and more particularly, but not exclusively, to smoothing the paste during the filling process.

Additive Manufacturing, or 3D printing, is a layer by layer method that is now widely used to make prototype parts and for small-scale manufacturing.

In general, additive manufacture uses resins and produces parts that are relatively soft.

Due to their relatively high melting temperatures, metal and ceramic materials are more difficult to use in additive manufacturing procedures.

Additive Manufacturing technologies are in general slow compared to conventional production processes such as machining etc. due to the building process of forming the part layer by layer.

In an effort to find a method of additive manufacture that was suitable for metals and ceramics, the present inventors designed the process described in International Patent Publication No. WO 2018/203331, the contents of which are hereby incorporated in their entirety into the present disclosure. In the process, additive manufacturing is combined with molding techniques in order to build shapes that have hitherto not been possible with conventional molding or machining technologies or in order to use materials that are difficult or impossible to use with known additive manufacturing technologies, or to build shapes faster than is possible with known Additive Manufacturing technologies. In the process described therein, additive manufacturing is used to make a mold and then the mold is filled with the material of the final product. Layers of the final product may be separately constructed with individual molds, where a subsequent layer is made over a previous layer. The previous layer may in fact support the mold of the new layer, as well as provide the floor for the new layer.

The material of the mold is typically a waxy material such as a resin, based on available or specialized 3D printing inks. The material used to fill the mold is typically a paste carrier with the product material as a powder. That is to say, the metal, or ceramic, paste is in a viscous liquid form. The material may be spread easily and subsequent sintering may cause the carrier to evaporate and the powder to fuse, providing a solid product.

As described therein, a specialized printing device is provided having two separate applicators, one for printing the mold and for example having three degrees of freedom as needed for 3D printing, and a second applicator provides paste for filling the mold once the mold is formed.

The printing device may use a roller to level the mold after printing.

Following spreading, then as described therein, the paste may need to be hardened and then cut to provide a smooth layer that is aligned with the mold. Leaving the paste correctly leveled along the mold and at an accurate height over the mold surface allows for a precise product to be formed. In particular, not enough paste may lead to a wrong build of the model, and too much paste, in excess of the mold surface, may also affect the required model.

It is noted that there is relative movement between the part that is being built and the roller. Hence applying the roller and then applying the blade cannot of itself guarantee a smooth plane, (they are anyway moving together . . . ) and a separate smoothing operation is necessary.

### SUMMARY OF THE INVENTION

The present embodiments provide a layering device whose aim is to fill the mold and to eliminate or significantly reduce a separate smoothing stage in the formation of each layer, by setting a blade or squeegee that spreads the paste to the same plane defined by the roller that smooths the mold.

According to embodiments of the invention a roller is used to press the mold wall, an applicator applies paste within the mold wall and a blade is used to spread the paste. The blade is adjusted to be at the height and orientation of the roller so that both the roller and the blade define the same plane in the mold. The roller combined with a paste applicator and the blade form the layering device which may serve as part of a 3D printer or additive manufacturing device. The height of the paste applicator may be coordinated with the roller and the blade.

The blade may accordingly be mounted on the same mounting as the roller to form such a layering device, and either or both of the blade and the roller may have provision for micro-adjustments. The applicator may be a slot die that applies paste over a preset width, or one or more point dispensers that apply paste at specified points. In order to fill mold shapes the point dispensers may be moved from side to side.

In the mounting, if the height of the roller is changed, the height of the blade is changed at the same time. Relative movements between the product or part being printed and the single mounting holding the blade and the roller thus do not affect the plane that the roller and the blade both define together.

It is noted that three processes of pressing of the mold after printing, applying the paste and spreading of the paste inside the mold, are carried out in a single pass. Optionally a further process of smoothing of the paste may be carried out.

According to an aspect of some embodiments of the present invention there is provided a layering device for preparation of layers being formed in additive manufacture, each layer formed by printing a mold wall to define a mold space and filling the mold space with a paste to form the layer, the layering device comprising:

a roller configured to roll the mold wall from above to form a mold layer surface in a plane; and

a blade configured to spread the paste to fill the mold space, wherein the blade is aligned into said plane to smooth the paste into said plane, the paste thereby confined by an upper surface that is continuous with said mold layer surface.

A paste applicator may be mounted on the layering device between the roller and the blade.

Embodiments may comprise an adjustable mounting for the blade, thereby to adjust the blade into a same height and orientation with the roller.

The layering device may include a mounting, the blade and the roller being mounted together on said mounting, and may be together with the applicator.

The mounting may allow for micro-adjustments.

The blade may be micro-adjustable on the mounting.

The roller may be micro-adjustable on the mounting.

The height of the roller over the layer and the height of the blade over the layer may change together.

The layering device may carry out the tasks of smoothing of the mold after printing, filling and spreading of the paste inside the mold in a single pass. Smoothing of the paste may also be carried out in a single pass or may follow drying of the paste.

An applicator for dispensing of the paste may be provided and may be adjustable and microadjustable, along with the roller and the blade.

The applicator may comprise a slot die extending widthwise over the layering device.

The slot die may be located on an adjustable mounting.

The applicator may be micro-adjustable.

The applicator may be positioned within a range of tens of microns of said plane.

The applicator may be at any of the following distances within the ranges of 30 microns, less than 30 microns, less than 25 microns, less than 20 microns, less than 15 microns, less than 10 microns, less than 5 microns and one micron.

The applicator may be a dispenser, and may be movable from side to side.

The paste may be metal or ceramic powder in a carrier.

According to a further aspect of the present embodiments there is provided a method of layerwise manufacture of a product, comprising:

For each layer of a plurality of layers:

Printing a mold wall to define a filling space.

Smoothing the mold wall from above with a roller to define a plane for an upper layer surface of said mold wall; and

Using a blade to spread a paste within the filling space such that a lower surface of said blade defines an upper layer surface of said paste, the method comprising pre-aligning the blade with said plane, the blade thereby causing said upper layer surface of said paste to be in said plane.

The method may involve using said upper layer surface as a base for a mold wall of a following layer.

The method may involve adjusting the blade into a same height and orientation with the roller.

The method may comprise using the blade and the roller on a common mounting.

The method may involve dispensing said paste from an applicator on said common mounting.

The method may involve a slot die extending across a printing width being used as the applicator.

The applicator may be a dispenser of the form of a syringe, and the method may comprise moving said syringe across a printing width in a direction perpendicular to motion of said common mounting.

The method may comprise applying micro-adjustments to the orientation or height of the blade or the roller or the applicator.

The method may comprise dispensing said paste from said slot die from a height of tens of microns or single microns from said plane.

The method may comprise using a single pass over the layer being manufactured to carry out the tasks of smoothing of the mold wall after printing, filling and spreading of the paste inside the mold space and smoothing of the paste.

According to a third aspect of the present invention there is provided a method of configuring a 3D printing device for layerwise printing of a part, each layer formed by printing a mold wall to define a mold space and filling the mold space with a paste to form the layer, the 3D printing device comprising:

at least one print head, configured to carry out 3D printing to form each mold wall using a mold material;

a roller configured to roll the mold wall from above to form a mold layer surface in a first plane; and

a blade configured to spread the paste to fill the mold space;

the method of configuring comprising aligning the blade into said first plane with said roller, thereby to smooth the paste into said plane, the paste thereby confined within an upper surface that is continuous with said mold layer surface.

According to a yet further aspect of the present invention, there is provided a layering device for preparation of layers being formed in additive manufacture, each layer formed by printing a mold wall to define a mold space and filling the mold space with a paste to form the layer, the layering device comprising:

a roller configured to roll the mold wall from above to form a mold layer surface in a plane;

a slot die configured to dispense said paste into said mold space; and

a blade configured to spread the paste to fill the mold space, wherein the blade is aligned into said plane to smooth the paste into said plane,

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified view from the side of a layering device made up of a mounting that holds a roller and a blade, for combined smoothing of the mold wall and spreading of paste during additive manufacture, according to embodiments of the present invention;

FIG. 2 is a simplified flow chart showing a mode of operation of additive manufacture using the embodiment of FIG. 1

FIG. 3 is a cutaway view from the side of the layering device corresponding to FIG. 1;

FIG. 4 is a plan view of the layering device of FIG. 1;

FIG. 5 is a 3D perspective view of the layering device and showing the relative motion of the mount with respect to the print tray in exemplary embodiments of the present invention;

FIG. 6 is a view from above of a variation of the layering device of FIG. 1;

FIG. 7 is a perspective view of the layering device of FIG. 6;

FIG. 8 is a side view of the layering device of FIG. 1 in which the die slot is lowered to the level of the mold walls to insert paste according to embodiments of the present invention;

FIG. 9 is a simplified diagram showing the mounting together with molded shapes on the table; and

FIGS. 10, 11 and 12 are a perspective view, a side view and a view from above respectively, of an alternative embodiment of the present invention in which the slot die, which dispenses over a width, is replaced by a single point dispenser such as a syringe, the syringe being movable in a perpendicular or other non-parallel direction in reference to the layering device movement direction.

### DESCRIPTION OF SPECIFIC EMBODIMENTS OF THE INVENTION

The present invention, in some embodiments thereof, as outlined above, relates to a process of mold preparation and paste filling of the mold and more particularly, but not exclusively, to smoothing the paste during the filling process.

After printing the new mold layer, a cylinder or roller is used to press and flatten the mold surface, typically a waxy surface, to some extent.

Paste is then applied to fill the mold to produce layer of the product or part.

The paste is now smoothed by a blade being passed over the top of the paste and the mold.

The blade, or squeegee, is calibrated in such a way that the blade and the cylinder are at the same height in reference to the upper plane of the mold.

Thus, the cylinder that presses the wax mold defines a plane during movement along the part to be printed. An applicator may also be aligned with the plane in order to apply paste at the same level. The plane defined by the blade in the wax is also along the same plane. The result is that the individual layer has an overall surface that is defined together for the mold and the paste.

In this way, the paste that has been applied is spread at the same level as the plane defined by the top of the mold, meaning the mold is filled completely but not over.

Advantages may include elimination of the need for cutting away excess paste.

There is a relative movement between the part that is being built and the roller. Hence separately applying the roller, the applicator and the blade cannot of itself guarantee a smooth plane. Using the present embodiments the relative movement between the layering device and the part does not affect the relative position between the blade and the roller. Using a layering device according to the present embodiments, the layer printing process is fast and the paste is spread immediately after being applied from the paste device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

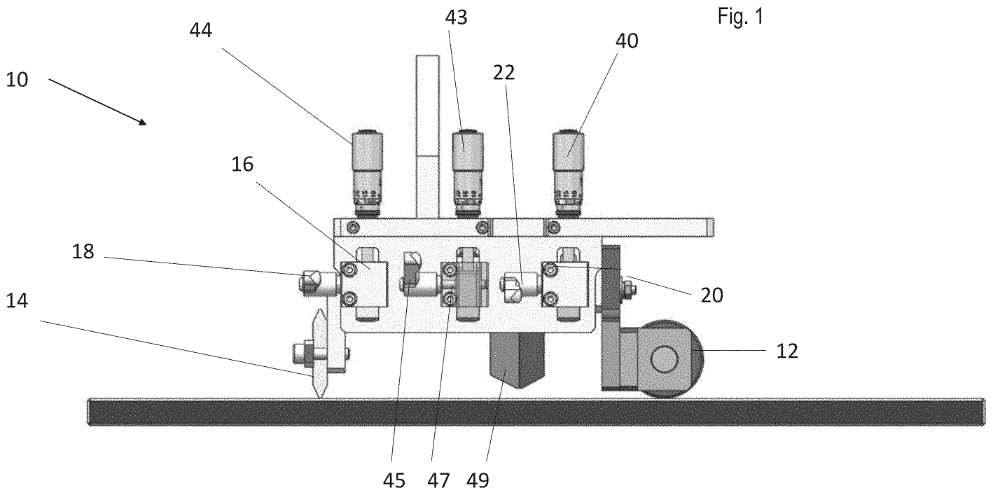

Referring now to the drawings, FIG. 1 illustrates a layering device that comprises a mounting 10 for a 3D printing device for layerwise printing of a part or a product. As explained, each layer is formed by printing a mold wall to that defines a closed mold space. The closed space is then filled with a paste to form the layer using an applicator. The 3D printing device comprises a nozzle that provides resin material, typically an inkjet nozzle, and the nozzle may carry out 3D printing to form the various mold walls for each layer using the resin or any other suitable mold material.

A roller 12 may be used to smooth the mold wall from above after printing, and the idea is to form a mold layer surface that lies in a well-defined a plane.

Paste is applied via slot die 49 or any other applicator, which will be discussed in greater detail below, and a blade 14 is used for spreading the paste to fill the mold space. The blade 14 is aligned according to the present embodiments into the same well-defined plane of the mold wall upper surface so as to smooth the paste to form a layer surface which is aligned in the plane with the mold wall upper surface. The paste may thus be confined within the mold walls and below an upper surface that is continuous with the mold layer surface. The applicator may also be commonly mounted with the roller and the blade, as shown.

An adjustable mounting 16 may be provided for the blade 14 to mount the blade and adjust the blade as needed so as to achieve the same height and orientation as the roller 12. Pin 18 may allow macro-adjustments and release of the blade. Micro-adjustment pin 44 allows for micro-adjustments. A similar adjustable mounting 20 may be provided for the roller and again, a macro adjustment pin 22 may be provided to allow for macro-adjustments and release. Micro-adjustment pin 40 may allow for micro-adjustments.

A further micro-adjustment pin 43 and macro-adjustment pin 45 operate adjustable mounting 47 which holds the slot die 49. Slot die 49 dispenses paste within the mold. Slot dies are known for dispensing coatings onto surfaces, however in the present embodiments they are used to fill molds. The slot die is generally constructed of two pieces of metal that fit together to leave an internal space to hold the material to be dispensed, and a slot through which the material is dispensed from the internal space. The slot size is a parameter that is optimized for the viscosity and flow rate of the material being dispensed. The distance between the slot die and the mold surface defines the amount of paste that is dispensed. Thus, the larger the distance the more material is dispensed and in the end wasted.

In the present embodiments, the distance is minimized so that less paste has to be wiped away by the blade. Furthermore, at a very small distance, paste cannot flow out of the slot unless the slot is located over a cavity, so that no paste is wasted over the mold wall for example. Thus, the distance between the slot and the mold surface may according to the present embodiments be kept to less than 30 microns or less than ten microns or to five microns or less.

The mounting 10 may hold both the blade 14 and the roller 12 and a paste applicator such as slot die 49, so that once adjusted there is no relative movement between the blade and the roller and both the blade and the roller are able to hold to the same plane. Thus both the blade and the roller may be subject to micro-adjustments on the mountings. Alternatively, only one of the blade and the roller may be made to be micro-adjustable with the other fixed as a reference. It is noted that all three mechanisms are together in one frame or cage, for example within frame 50, moving relative to the part being printed, and all three are preferably aligned.

In embodiments, the mounting is adjustable so that the height of the roller over the layer and the height of the blade over the layer change together.

The mounting, with the roller and the blade and an applicator, mounted together, may thus be able to carry out all three tasks of smoothing of the mold after printing, applying the paste to the mold, and spreading of the paste inside the mold and smoothing of the paste, all in a single pass of the mounting over the layer being formed.

The paste may comprises metal or ceramic powder in a carrier, so as to provide a method of manufacturing of a part or product made of metal or ceramic using additive manufacture technology.

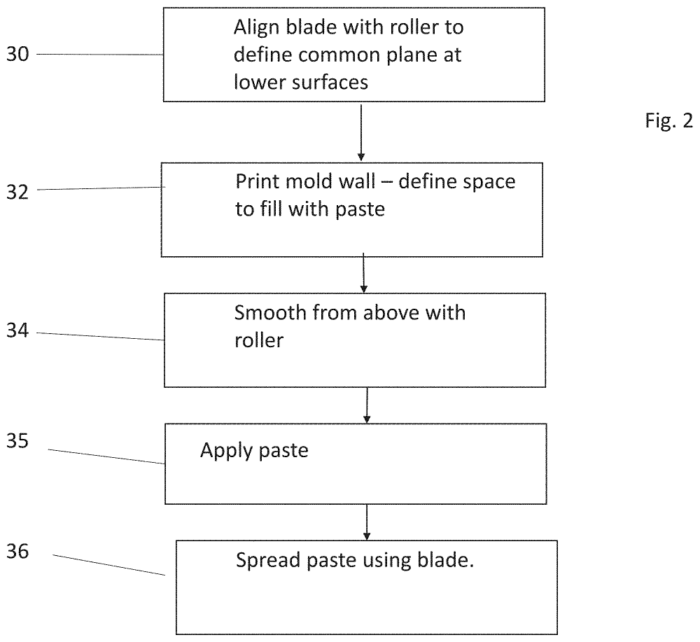

Reference is now made to FIG. 2, which is a simplified flow chart illustrating use of the apparatus of FIG. 1 according to embodiments of the present invention.

A method of layerwise manufacture of a product is provided in which multiple layers are provided one after the other. In embodiments, other operations may be inserted between layer printing.

Initially the machine is set up 30 by aligning the blade with the roller and slot die, to define a common plane by the lower surfaces of the blade and of the roller and the motion axis. In the case of a point dispenser, the alignment may be less precise or the point dispenser may be aligned higher to provide more material or the like. That is to say, the roller is aligned to smooth a surface into a particular plane and the lower surface of the blade is aligned to smooth paste into that same plane. Alignment may be carried out initially and checked at regular intervals. Depending on the way in which the machine holds the alignment, realignment may need to be carried out more or less often and the frequency may vary according to the materials being used in the mold and/or the paste.

The mold wall is then printed 32 using a print head having at least one printing nozzle. The nozzle may be an inkjet nozzle. The mold wall may be a closed shape defining an inner space, which is to be filled with paste.

The upper surface of the mold wall typically requires smoothing as is common in additive manufacture. Smoothing the mold wall is carried out 34 from above with the roller and the upper surface of the mold is now within the alignment plane.

Paste is dispensed using the slot die—35, and the blade is then used 36 to spread the paste within the filling space, the closed area with the mold walls. Due to the pre-alignment, the blade lower surface is aligned with the smoothed surface of the mold wall following rolling. Thus, the blade ensures that the upper surface of the paste is within the alignment plane and continuous with the mold upper surface.

The aligned upper layer surface is then available as a base for the mold wall and the paste of the next layer.

Pre-aligning the blade may involve adjusting the blade into the same height and orientation with the roller, and the blade and the roller may be located on a common mounting, which allows for micro-adjustments to the orientation or height of the blade or the roller to achieve the alignment.

The method may thus allow a layer to be completed in a single pass that is able to carry out all the tasks of smoothing of the mold wall after printing, filling and spreading of the paste inside the mold space and smoothing of the paste.

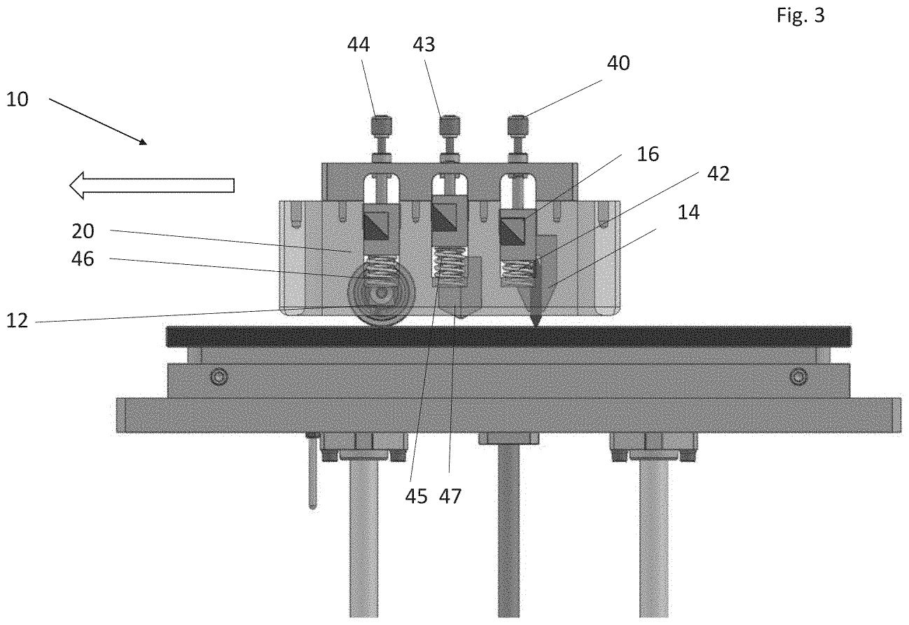

Reference is now made to FIG. 3, which is a cross section of the printing device mounting 10 of FIG. 1.

A roller 12 may be used to smooth the mold wall from above after printing, and the idea is to form a mold layer surface that lies in a well-defined a plane.

A blade 14 is used for spreading paste, dispensed from the slot die, to fill the mold space. The blade 14 is aligned according to the present embodiments into the same well-defined plane of the mold wall upper surface so as to smooth the paste to form a layer surface, which is aligned in the plane with the mold wall upper surface. The paste may thus be confined within the mold walls and below an upper surface that is continuous with the mold layer surface.

Adjustable mounting 16 has a micro adjustment pin 40 and resilient mounting 42 which is adjusted by the pin 40 to provide fine adjustments for the blade 14, in order to adjust the blade as needed so as to achieve the same height and orientation as the roller 12. A similar adjustment mounting 20 may be provided for the roller and again, a micro-adjustment pin 44 may be provided to allow for micro-adjustments on spring mounting 46 Likewise adjustment mounting 49 may be provided for the slot die and macro and micro adjustments may be made using adjustment pins 43 and 45.

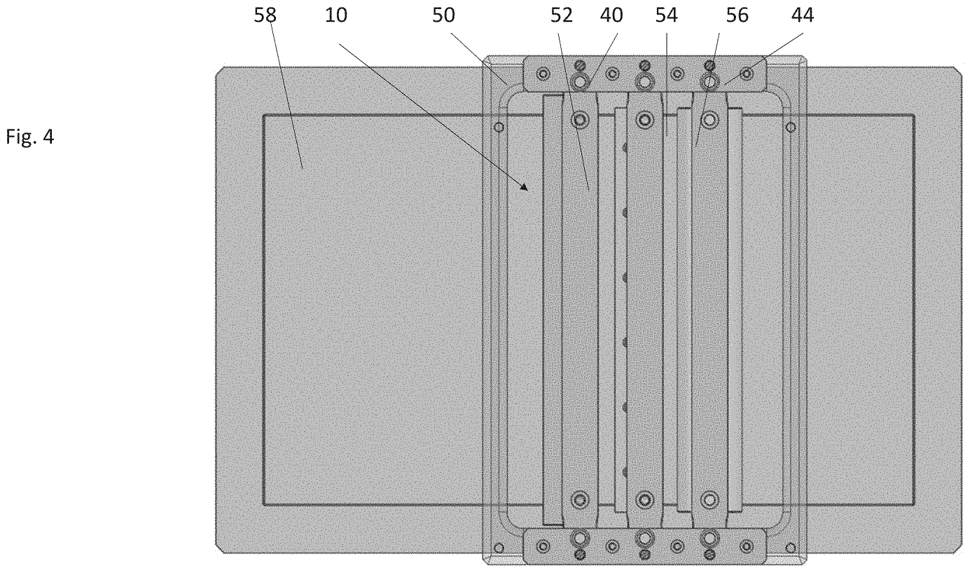

Reference is now made to FIG. 4, which is a view from above of the embodiment of FIG. 4. The mounting 10 consists of a frame 50 and first 52, second 54 and third 56 cross supports. The first support 52 holds the roller and the third 56 holds the blade. The micro-adjustment pins 40 and 44 are located at either end of the supports. The mounting slides over table 58 on which the printing is carried out.

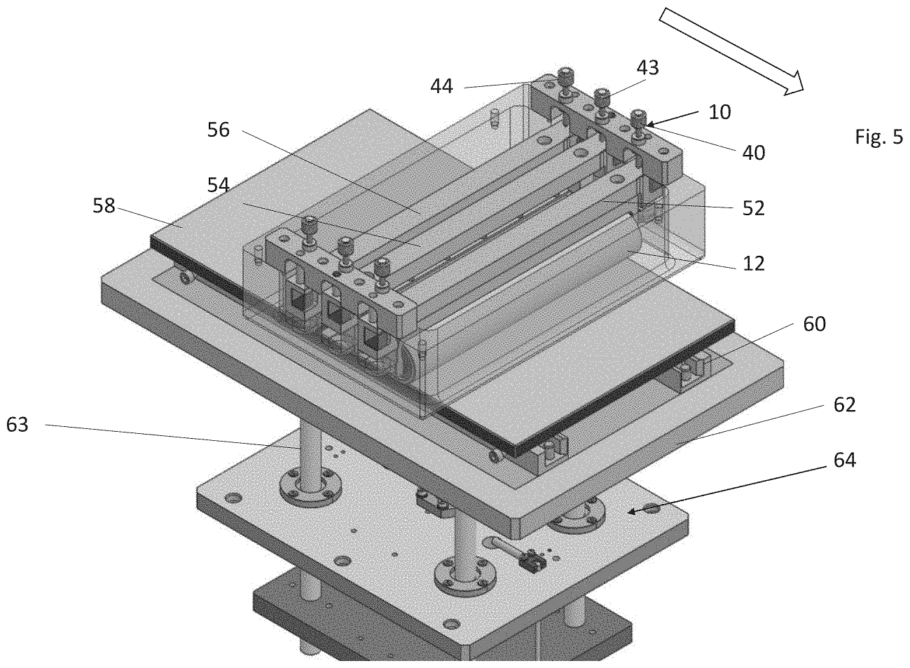

Reference is now made to FIG. 5, which is a 3D perspective cutaway view of the printing apparatus of FIG. 1. The frame 50 is not visible but, as in FIG. 4, the mounting 10 consists of first 52, second 54 and third 56 cross supports. The first support 52 holds the roller and the third 56 holds the blade. The micro-adjustment pins 40 and 44 are located at either end of the supports. The mounting, or layering device 10, moves relatively to the table 58 on which the printing is carried out. The table 58 is fixed on locking rails 60 over a base 62 which in turn is held up by stand 64. In general any embodiment in which the mounting 10 moves relative to the part being printed may be used and the construction of FIG. 5, in which the table slides under the mounting is merely exemplary. The layering device moves relative to the table in such a way that the roller meets the mold before the blade arrives. Pillars 63 allow for lowering of the table 58 for printing successive layers.

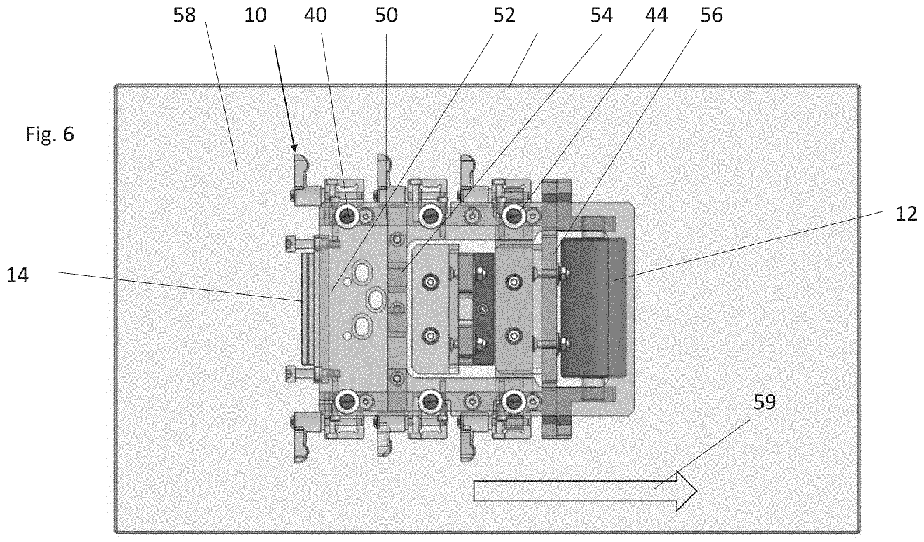

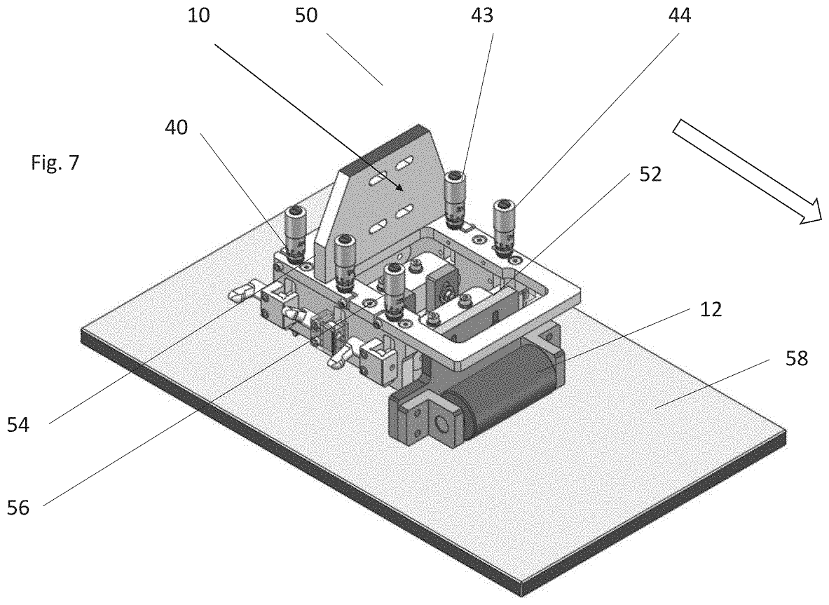

Reference is now made to FIGS. 6 and 7, which illustrate a variation of the mounting 10 of FIG. 1 for a smaller machine. Parts that are the same as in previous figures are given the same reference numerals and are not described again except as needed for an understanding of the present embodiment. FIG. 6 is a view from above and FIG. 7 is a perspective 3D view. In the variation the blade and the roller are narrower than the mount and are held inwardly of the frame. The mount or layering device 10 moves in the direction of arrow 59 during the layering process.

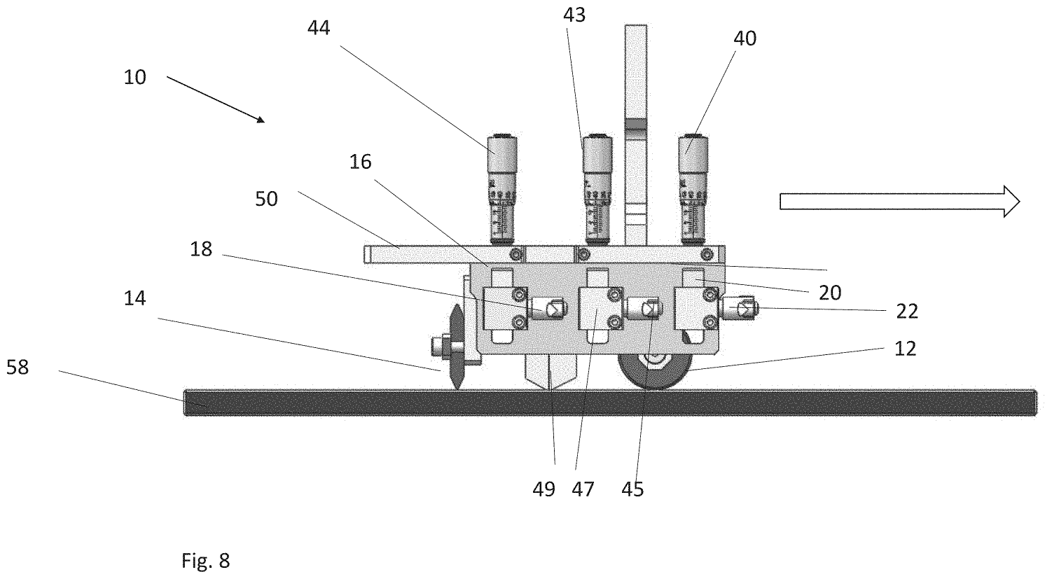

Reference is now made to FIG. 8, which is a simplified schematic diagram showing a side view of the mounting 10 of FIG. 1 in which the slot die 49 is lowered to inject paste material into the mould. Parts that are the same as in previous figures are given the same numbers and are not discussed again except as needed for an understanding of the present embodiment. Lowering the slot die to the level of the mold may help to ensure that paste is not extruded on the mold itself, as there is no space under the slot.

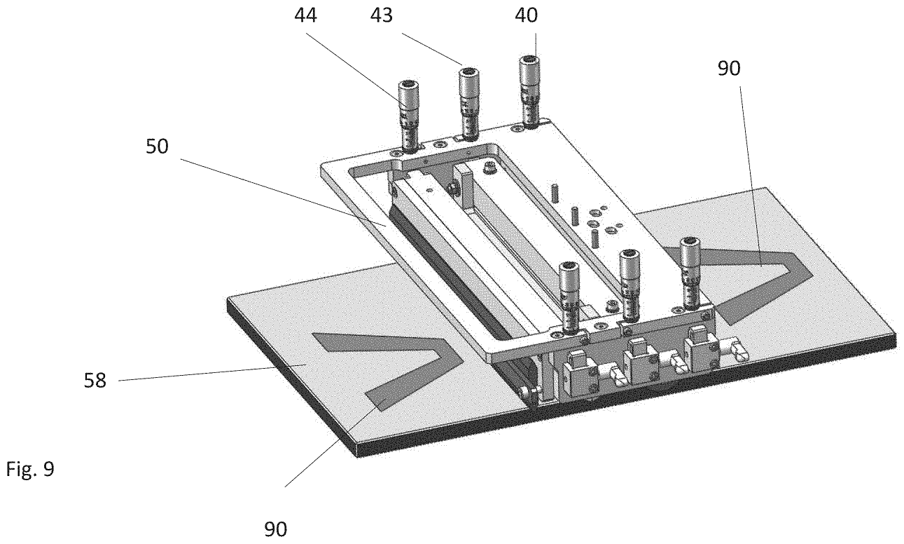

Reference is now made to FIG. 9, which is a simplified diagram showing the mounting of FIG. 8 in a perspective view from above. Parts that are the same as in previous figures are given the same numbers and are not discussed again except as needed for an understanding of the present embodiment. On printing table 58 are two molded shapes 90 to be filled with paste. The layering device moves back and forth and forms each layer in one pass over the table and fills each shape with paste. Operational passes are in the direction in which the roller is at the front end. Return moves have the blade at the front.

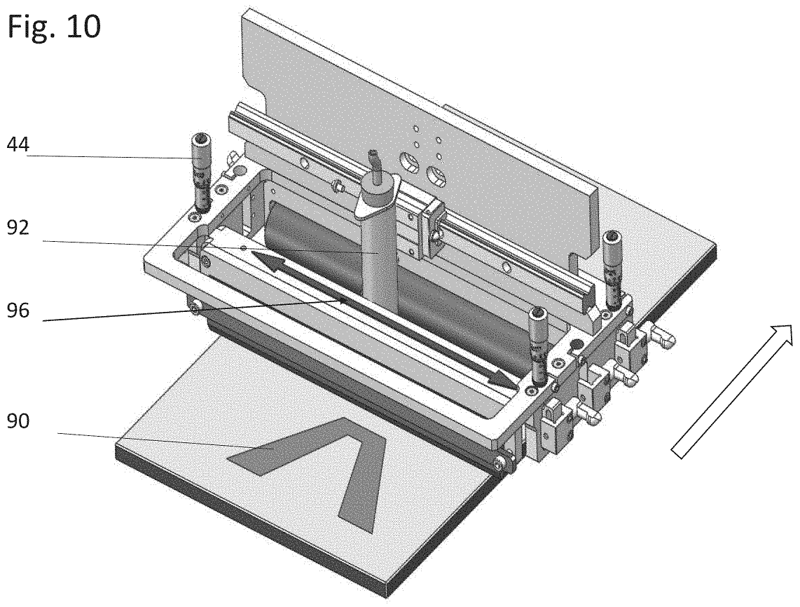

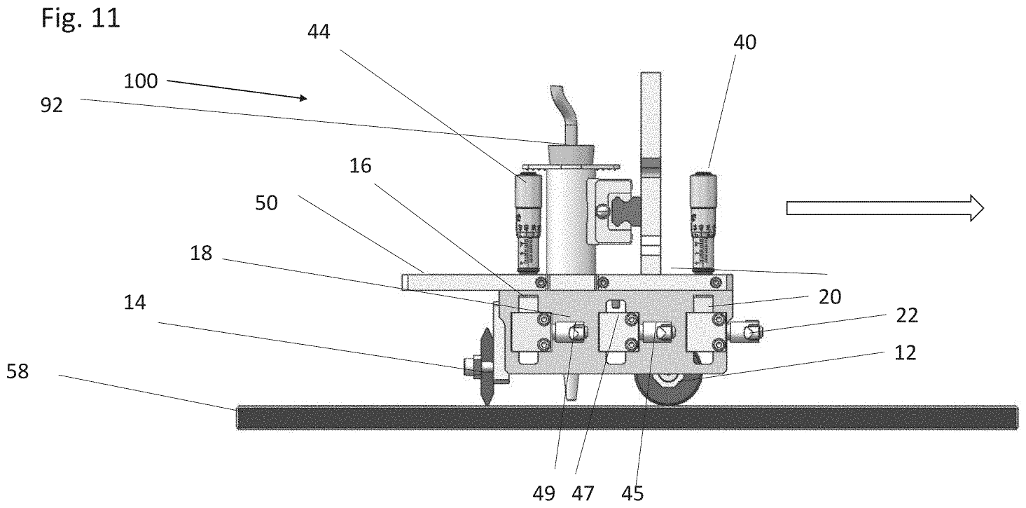

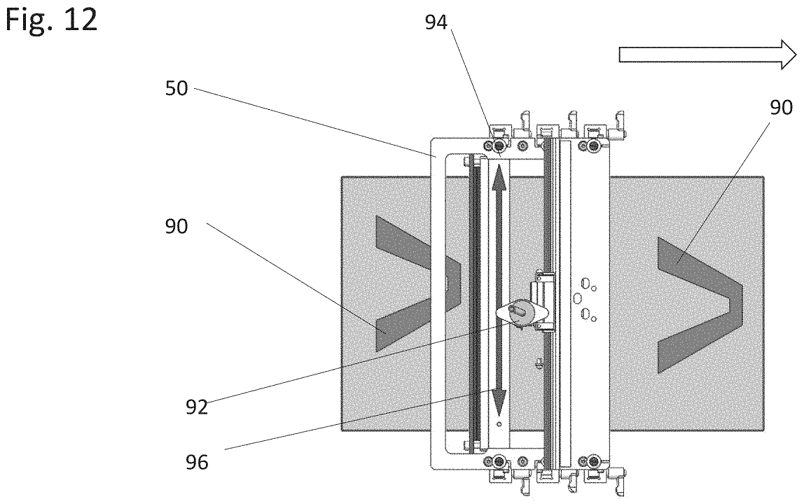

Reference is now made to FIGS. 10, 11 and 12, which a perspective view, a side view and a view from above of a variation of the mounting of FIG. 1. Parts that are the same as in previous figures are given the same numbers and are not discussed again except as needed for an understanding of the present embodiment. In mounting 100, instead of a slot die that extends over the width of the mounting, one or more single point dispensers, such as a syringe 92 provides the paste. The single point dispenser 92 is centrally mounted and can be microadjusted. In use the single point dispenser 92 moves from side to side, in a direction, which is typically perpendicular, or any other suitable angle relative to the device direction as indicated by arrow 96 and dispenses paste where necessary in a controllable way. Such movement of the dispenser is referred to herein as being from side to side. Thus, a suitable diagonal angle combined with forward movement of the carriage at a given speed may generate a perpendicular line of paste dispensing. Alternatively, the side to side movement may be carried out when the mounting is stationary, the mounting then moving forward between lines. Alternatively, both the mounting and the syringe or other single point dispenser may move at the same time, giving an overall helical shape of paste, which is then smoothed out using the blade.

Examples of single point dispensers include syringes in general, peristaltic pumps, pneumatic syringes, the, any kinds of manual and powered syringes or syringe dispensers, servo-controlled auger pumps such as the Preeflow™ dispenser provided by Viscotec, and micro-dispensers. The various dispensers may be controlled in various ways, via pressure and the like.

It is expected that during the life of a patent maturing from this application many relevant pastes and printing heads will be developed and the scopes of the corresponding terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A layering device for preparation of layers being formed in additive manufacture, each layer formed by printing a mold wall to define a mold space and filling the mold space with a paste to form the layer, the layering device comprising:
a roller configured to roll the mold wall from above to form a mold layer surface in a plane;
a blade configured to spread the paste to fill the mold space; and
an adjustable mounting for the blade, therewith to adjust the blade into a same height and orientation with the roller, wherein the blade is aligned into said plane to smooth the paste into said plane, the paste thereby confined by an upper surface that is continuous with said mold layer surface.

2. (canceled)

3. The layering device of claim 1, comprising a mounting, the blade and the roller being mounted together on said mounting.

4. The layering device of claim 3, wherein the mounting comprises micro-adjustments.

5. The layering device of claim 4, wherein one member of the group consisting of the blade and the roller is micro-adjustable on the mounting.

6. (canceled)

7. The layering device of claim 1, configured such that the height of the roller over the layer and the height of the blade over the layer change together.

8. The layering device of claim 1, configured to carry out the tasks of smoothing of the mold after printing, filling and spreading of the paste inside the mold and smoothing of the paste in a single pass.

9. The layering device of claim 1, further comprising an applicator for dispensing of said paste.

10. The layering device of claim 1, wherein the applicator comprises a slot die extending widthwise over the layering device.

11. The layering device of claim 10, wherein the slot die is located on an adjustable mounting.

12. The layering device of claim 9, wherein the applicator is micro-adjustable.

13. The layering device of claim 9, wherein the applicator is positioned within a range of tens of microns of said plane.

14. The layering device of claim 9, wherein the applicator is at a distance from said plane being one member of the group consisting of: 30 microns, less than 30 microns, less than 25 microns, less than 20 microns, less than 15 microns, less than 10 microns, less than 5 microns and one micron.

15. The layering device of claim 9, wherein the applicator is a dispenser, and is movable from side to side.

16. The 3D layering device of claim 1, wherein the paste comprises metal or ceramic powder in a carrier.

17. A method of layerwise manufacture of a product, comprising:
For each layer of a plurality of layers:
Printing a mold wall to define a filling space;
Smoothing the mold wall from above with a roller to define a plane for an upper layer surface of said mold wall; and
Using a blade to spread a paste within the filling space such that a lower surface of said blade defines an upper layer surface of said paste, the method comprising pre-aligning the blade with said roller and said plane, the blade thereby confining said upper layer surface of said paste to be within said plane.

18. The method of layerwise manufacture according to claim 17, comprising using said upper layer surface as a base for a mold wall of a following layer.

19. The method of layerwise manufacture according to claim 17, comprising adjusting the blade into a same height and orientation with the roller.

20. The method of layerwise manufacture of claim 17, comprising using the blade and the roller on a common mounting.

21. The method of layerwise manufacture of claim 20, comprising dispensing said paste from an applicator on said common mounting.

22. The method of claim 21, wherein said applicator is one member of the group consisting of:
a slot die extending across a printing width; and
a syringe-type dispenser, the method comprising moving said syringe-type dispenser across a printing width in a direction perpendicular to motion of said common mounting.

23. (canceled)

24. The method of layerwise manufacture of claim 21, comprising one member of the group consisting of:
applying micro-adjustments to the orientation or height of the blade or the roller or the applicator; and
dispensing said paste from said slot die from a height of tens of microns or single microns from said plane.

25. (canceled)

26. The method of layerwise manufacture of claim 17, comprising a single pass over the layer being manufactured to carry out the tasks of smoothing of the mold wall after printing, filling and spreading of the paste inside the mold space and smoothing of the paste.

27. The method of layerwise manufacture of claim 17, wherein the paste comprises metal or ceramic powder in a carrier.

28. A method of configuring a 3D printing device for layerwise printing of a part, each layer formed by printing a mold wall to define a mold space and filling the mold space with a paste to form the layer, the 3D printing device comprising:
at least one print head, configured to carry out 3D printing to form each mold wall using a mold material;
a roller configured to roll the mold wall from above to form a mold layer surface in a first plane; and
a blade configured to spread the paste to fill the mold space;
the method of configuring comprising aligning the blade into said first plane with said roller, thereby to smooth the paste into said plane, the paste thereby confined within an upper surface that is continuous with said mold layer surface.

29. A layering device for preparation of layers being formed in additive manufacture, each layer formed by printing a mold wall to define a mold space and filling the mold space with a paste to form the layer, the layering device comprising:
a roller configured to roll the mold wall from above to form a mold layer surface in a plane;
a slot die configured to dispense said paste into said mold space; and
a blade configured to spread the paste to fill the mold space, wherein the blade is aligned into said plane to smooth the paste into said plane.
